(19) United States
(12) Patent Application Publication
(10) Pub. No.: US 2012/0144320 A1
(43) Pub. Date: Jun. 7, 2012

(54) SYSTEM AND METHOD FOR ENHANCING VIDEO CONFERENCE BREAKS

(75) Inventors: Amit MISHRA, Pune (IN); Srinivasan Narayanan, Pune (IN); Anand Paithankar, Pune (IN)

(73) Assignee: Avaya Inc., Basking Ridge, NJ (US)

(21) Appl. No.: 12/960,163

(22) Filed: Dec. 3, 2010

(51) Int. Cl. G06F 3/01; G06F 15/16

(52) U.S. Cl. 715/753

(57) ABSTRACT

Disclosed herein are systems, methods, and non-transitory computer-readable storage media for enhancing a video conference break. The method can be implemented on any or all participants' client device or on a network-based device. A client-side system configured to practice the method detects, at a client device of a participant in a video conference, a beginning of a break in the video conference, gathers information describing a current status of the video conference, and displays, at the client device of the participant, the information. A network-based system maintains a current status of a video conference connecting a group of client devices, monitors the video conference to detect a beginning of a break, and, when the beginning of the break is detected, transmits at least part of the current status to each of the group of client devices for display to respective users of the group of client devices.

### BACKGROUND

1. Technical Field

The present disclosure relates to video conferencing and more specifically to enhancing how breaks are presented during a video conference.

2. Introduction

Video conferences are an increasingly common part of business because they allow for very natural interactions and collaboration. As the frequency and length of video conferences grows, so do the number and duration of breaks taken during video conferences. Video conference participants often prefer breaks as a simple alternative to ending and restarting the video conference because the video conference. In one common embodiment, video conferences present the video feed from the remote end and mute the audio during such a break. If a late-arriving participant joins the video conference mid-break, they may walk into an unoccupied room and not know what the status of the meeting is or if it is the correct meeting. It is difficult for such a late-arriving participant to quickly get oriented and know what to prepare for, whom to ask for assistance, and so forth.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein indicate a break status of a video conference during the break in the video conference. Further, the break status can include optional additional information, such as a resume time, conference participants, a conference organizer and/or actual or planned progress within a meeting agenda. Conference participants can interact with portions of the break status during the break. While the principles herein are discussed in terms of a video conference, the same principles can be applied to other types of communications as well.

Disclosed are systems, methods, and non-transitory computer-readable storage media for enhancing a video conference break from a client-side perspective. The client device of a participant in a video conference detects a beginning of a break in the video conference at a first time. For example, a conference call server can transmit a signal indicating the beginning of a break and a duration of the break, a signal indicating the end of a break, and so forth. In another example, the client device analyzes the video stream for a particular video, audio, and/or metadata cue associated with a break. The cue can be something as simple as when the other participants leave their respective video streams or something more complex such as a physical gesture by one of the participants. The client device gathers information describing a current status of the video conference associated with the first time and displays the information at the client device of the participant at a second time later than the first time. The system can also detect an end of the break in the video conference and stop displaying the information. The system can display the information in many different ways, including, for example, a semi-transparent overlay on top of the video conference, side by side with the video conference, a temporary replacement for the video conference, and a scrolling feed overlaid on or beside the video conference.

Also disclosed is a network-based system embodiment for enhancing a video conference break. This system maintains a current status of a video conference connecting a group of client devices and monitors the video conference to detect a beginning of a break at a first time. When the system detects the beginning of the break, the system transmits at a second time, later than the first time, at least part of the current status associated with the first time to each device in the group for display to their respective user.

Also disclosed is a remote participant client device in the video conference that enhances a video conference break. The remote participant client device maintains a current status of a video conference connecting the client conferencing device to other client conferencing devices, and receives an indication of a beginning of a break in the video conference at a first time. Then the remote participant client device transmits at least part of the current status associated with the first time, at a second time later than the first time, to each of the other client conferencing devices for display to respective users of the other client conferencing devices.

These approaches can enhance video conference breaks by displaying relevant information instead of showing a blank image or showing a video stream that has little or no content of interest. This approach can benefit video conference participants who were part of the conference before the break as well as video conference participants who join the conference mid-break and do not know the current status of the conference.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example network configuration for conducting a video conference;

FIG. 3 illustrates a first exemplary enhanced display of a video conference break;

FIG. 4 illustrates a second exemplary enhanced display of a video conference break;

FIG. 5 illustrates an example client-side method embodiment for enhancing a video conference break; and

FIG. 6 illustrates an example server-side method embodiment for enhancing a video conference break.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for enhancing breaks in video conferences. As with in-person meetings, video conferences also include breaks because it is often inconvenient and disruptive to stop the video conference session only reestablish the video conference a short time later. So video conference participants often will break for a short time and resume. The principles disclosed herein apply to such breaks in a video conference or other communication. For example, instead of just showing an empty room, a video stream of a still image, or some other not-so-helpful image, the break display can also include information such as an agenda position, current participants, expected participants, and so forth. The break display can be interactive as well, allowing participants to instant message during the break, exchange files, conduct a side-bar video conversation, and so forth.

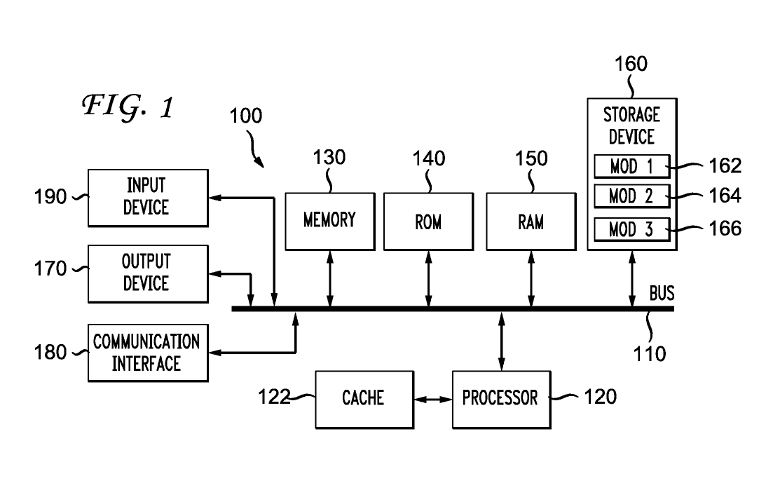

A brief introductory description of a basic general purpose system or computing device in FIG. 1 which can be employed to practice the concepts is disclosed herein. A more detailed description of exemplary network configurations, methods, sample displays and interfaces will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

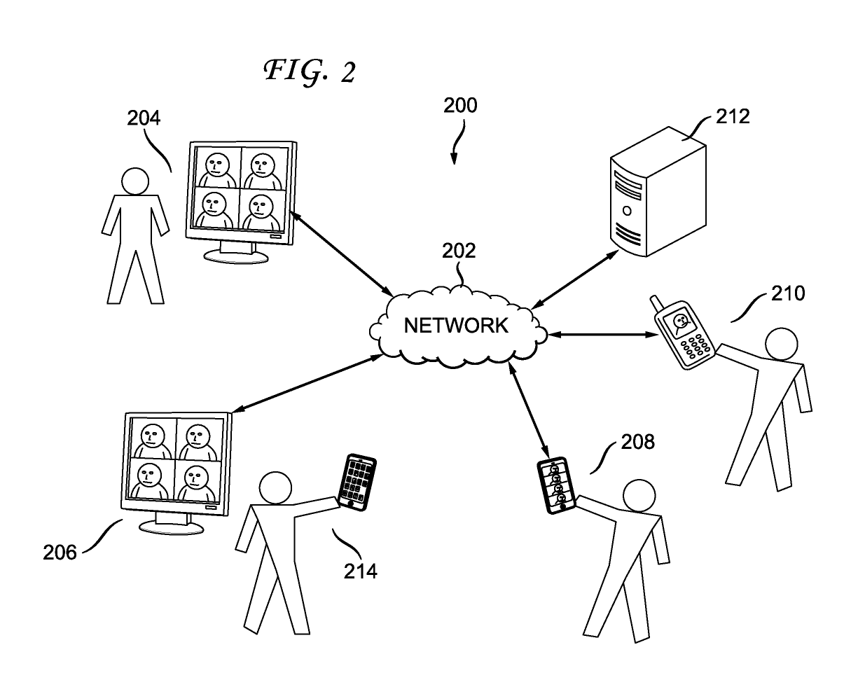

Having disclosed some components of a computing system, the disclosure now returns to a discussion of breaks in video conferences. FIG. 2 illustrates an example network configuration 200 for conducting a video conference. In this configuration 200, the various components communicate via a communication network 202, such as the Internet, the public switched telephone network, a virtual private network, a local area network, a metropolitan area network, and/or other types of networks. A video conference can include participants such as a desktop computer 204, a television display 206, or other simple video output device, and a corresponding handheld device 214 for controlling and interacting with the video conference, a handheld device 208 such as a tablet computer, and a smartphone 210 or other portable device. In one aspect, a video conferencing server 212 resides in the network 202. The video conferencing server 212 can distribute video from client to client, perform synchronization tasks, facilitate extra-conference communications such as instant messages, or side bars, and otherwise provide support for the video conference.

The configuration 200 shown here can provide video conference services in any of a number of variations. In one variation, the various clients 204, 206, 208, 210 connect to the server 212 that organizes and manages the video conference. For example, each client transmits its video signal to the video conference server 212 that then transmits the appropriate signals back to the clients. Communications between clients pass through the server 212 and the server 212 performs the tasks necessary for enhancing video breaks. In another variation, one or more of the clients takes the place of the server. For example, one of the clients is a video conference call organizer. Each of the other clients connects to the organizer client. The organizer client then transmits the appropriate signals to the other clients. In this variation, the organizer client performs the actions of the server 212, such as enhancing breaks in the video conference, as well as participating in the video conference call as a client.

In yet another variation, multiple clients communicate between each other directly for a video conference in a pure peer-to-peer approach without the aid of a central server or an organizer client. In this aspect, each client is responsible for enhancements to breaks in its own display of the video conference. Further, hybrids of these variations are possible. For example, a peer-to-peer group of clients in a first video conference can bridge with a second video conference run by a central server. The peer-to-peer group of clients can treat the central server as another peer, and the central server can treat the each of the peers as one of the clients. This and other hybrid variations exist.

During a video conference, a conference organizer or any other user can initiate a break in the video conference. Users can initiate a break by pushing a special button on their video conferencing hardware, typing a particular sequence of keys on their general-purpose computing device that is displaying the video conference, via interactions with a companion device such as a smartphone, voice command, gesture command, and so forth. In one variation, one participant is unable to initiate the break alone and requires the consent of at least one other participant. A user, conference organizer, third party, or an automated system can schedule breaks at set intervals, such as scheduling a 5 minute break to occur at least once every hour, or scheduling a 15 minute break from 2:30 pm to 2:45 pm.

In another embodiment, the system 100 automatically detects when all the participants have left the screen, such as through face recognition and tracking, and self-initiates a break at that time. In the instance where no human participant initiated the break, the system can automatically resume when a certain number of participants have returned (such as one, two, or more). In one aspect, the system performs face recognition to determine that the returning participants are the same (or a subset of the same) participants that left at the beginning of the break so that the conference does not resume with the wrong people. Alternatively, the system can resume when a minimum number of participants have returned for a minimum time threshold. For example, when at least half of the participants have returned for a total of 2 minutes, the system can suggest textually, audibly, or visually “Are you ready to resume?” In yet another variation, the system, a conference manager or the participants can define a quorum of “required participants” who must be present before resuming the conference after the break. In other cases, human participants can click a button or provide other input to resume from a break. When the break starts, the system can also suspend activities such as recording or transcription and display the status of such suspended activities. Further, the system can allow users to browse recorded video or transcriptions during the break.

The disclosure now turns to a more detailed description of some exemplary enhanced displays during a video conference break.

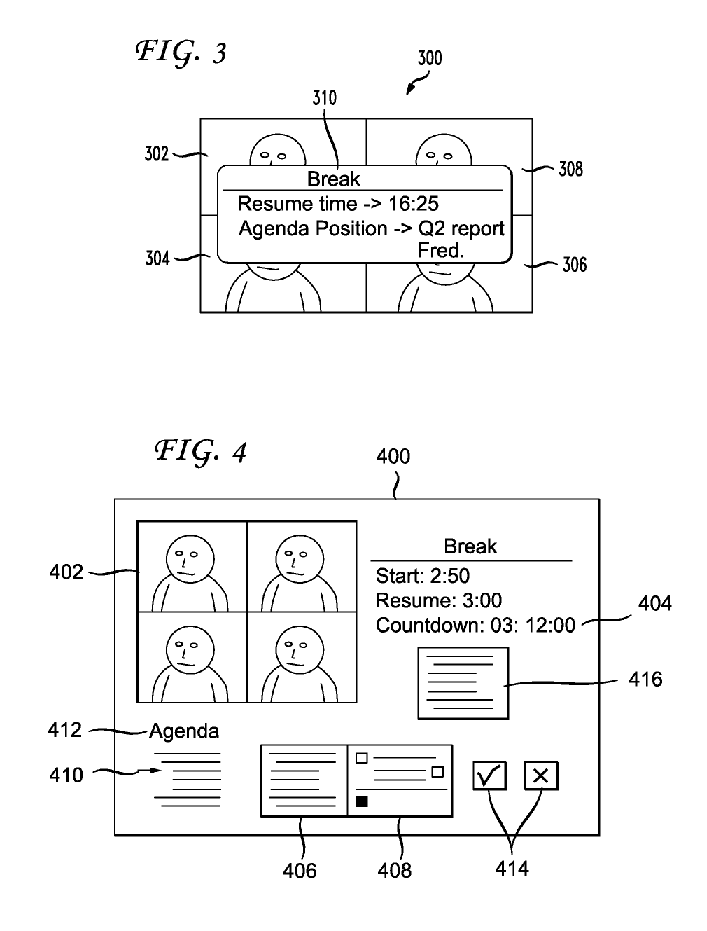

FIG. 3 illustrates a first exemplary enhanced display 300 of a video conference break. In this display 300, the exemplary video conference is a four-way video conference with a pane for each participant 302, 304, 306, 308. When the video conference enters a break, the system 100 can display an overlay break panel 310 indicating the break status and optional additional information, such as an expected resume time, and an agenda position. For example, the agenda position can include an upcoming topic and who is scheduled to address the upcoming topic. The overlay break panel 310 can be located anywhere on the screen and can be opaque and/or semi-translucent. A user can manipulate the overlay break panel 310, such as cycling through different informational displays, dragging or resizing the overlay break panel 310, and so forth.

While the display 300 illustrates a simple variation of the break panel 310 that provides for limited user interactions, FIG. 4 illustrates a more complex exemplary enhanced display 400 of a break status that provides for more user interactions. In this example, panes 402 of a four-way video conference are shrunk from full screen to occupy a smaller region of the screen and make room for information, user interface elements, and options for the enhanced break display. The display 400 can include a timing portion 404 that displays a break start time, a break end time (or video conference resume time), and/or a countdown to the break end time. The display 400 can include a list of actual, required, and/or invited video conference participants 406, contact information for a main contact such as a conference organizer, and a communications panel 408 to communicate with other video conference participants, such as an instant messaging or a document exchange panel. The display 400 can include a list of participants with presence information 416. For example, one participant is only available via the video conference, but others may be available via other modalities as well, such as instant messaging, text messaging, Google Wave, email, and so forth. Users can manipulate the presence information to initiate sidebars or other communications outside the video conference.

Further, the display 400 can include an agenda 412 and a current position 410 within the agenda. The agenda 412 can also indicate the next scheduled item in the agenda to discuss, only a remaining portion of the agenda, which participants are scheduled to address which portions of the agenda, an agenda summary, highlights of the video conference so far (in transcription form, audio form, and/or video form), agreements or resolutions reached based on agenda items, a proposed or tentative agenda for a follow-up meeting, and so forth. The agenda 412 can be interactive, for example, allowing a user to expand and collapse agenda items to see more or less as desired. In one variation, this interactive element is a ‘meeting sticky’ that indicates what happened in the previous conference session and what is expected to be discussed in the next (or current) session. Participants can also request the current agenda via an interactive sticky.

In another variation, the interactive display 400 can include entertainment and/or other options to keep the attention of participants who remain during the break or return early. For example, the system can provide a way for users to search the conference content previous to the break, play games during the break either individually or with other local or remote participants, or browse for resources related to the conference call. In one aspect, the games can be related to the conference call, such as a trivia question game based on information discussed in the conference call leading up to the break, or can include a poll spurring additional thought on topics brought up in the conference call.

The system 100, a server or one or more of the client devices, can detect progress of the video conference based on an agenda corresponding to the video conference. The system can update the agenda for the break based on the progress detected. In one aspect, the system can also update the agenda in real time for participants to view during non-break portions. The system can detect agenda progress based on speech recognition, natural language processing, pattern matching, image detection, heuristics, and/or an indication received from one of a conference organizer and a conference participant. For example, the system can detect a conference organizer's position in an agenda document, detect which portions the organizer and/or other participants have taken notes on, and so forth.

The system 100 can detect notes input via a separate device such as a scribble pad. The scribble pad can automatically provide a new page whenever the topic changes or the agenda progresses to a new agenda item, for example, at a new slide in a presentation or during a change of context by organizer, or change of speaker. The system can archive the notes from the scribble pad and make them accessible along with the transcript. The system can also coordinate notes taken via multiple scribble pads by multiple conference participants at different locations.

Further, the enhanced display can include interactive user interface objects 414. In this example, the interactive user interface objects 414 are a check and an X (indicating affirmative and negative). Before going to a break, a conference organizer can pose a question to the other video conference participants such as “Do you agree with the quarterly proposal from Barbara?” During the break, participants answer the question via the interactive user interface objects 414, clicking the checkbox for yes and the X for no. The conference organizer sees the results on his display updated in real time as participants provide answers. In one aspect, the results are anonymous, but the system can also track who provided which answers to the conference organizer The system can also display the results (or progress of receiving results) to non-organizer participants, depending on the sensitivity of the question and answers as indicated by the call organizer and/or the participant posing the question.

The display 400 can use different sizes, colors, positions, icons, patterns, and so forth to provide additional information regarding the agenda 412 and/or other items in the enhanced break display 400.

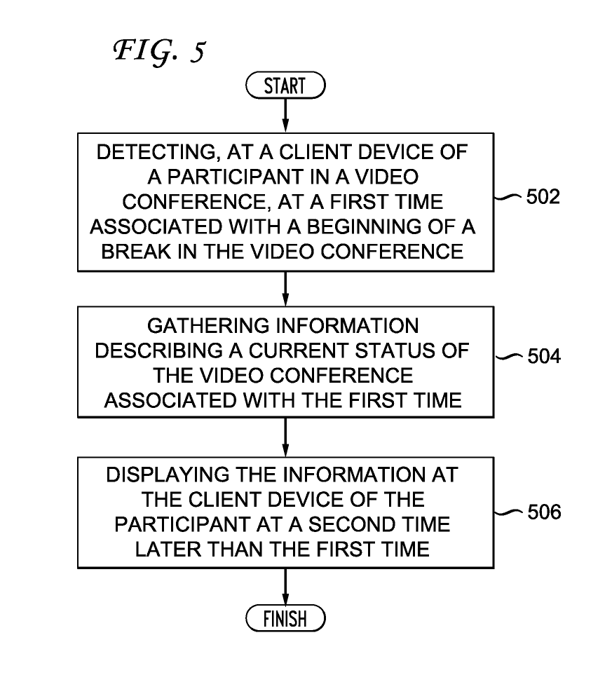

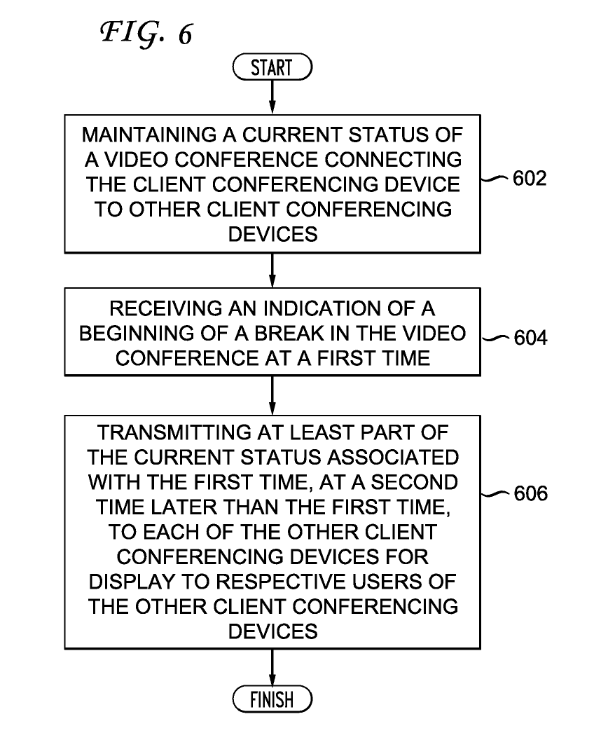

Having disclosed some basic system components and concepts, the disclosure now turns to the exemplary method embodiments shown in FIGS. 5 and 6. For the sake of clarity, the methods are discussed in terms of an exemplary system 100 as shown in FIG. 1 configured to practice the method. The steps outlined herein are exemplary and can be implemented in any combination thereof, including combinations that exclude, add, or modify certain steps. FIG. 5 illustrates an example client-side method embodiment for enhancing a video conference break.

The system 100 detects, at a client device of a participant in a video conference, at a first time, a beginning of a break in the video conference (502). The system 100 can detect the beginning of the break based on user input from a local and/or remote user. The user input can include at least one of a button press, a touch gesture, a motion gesture, a voice command, a mouse click, and an agreement between at least two separately located participants in the video conference. The button press can toggle between a break and a non-break state in the video conference. In one aspect, the system 100 detects, such as via face tracking, when a certain portion or number of participants have left the video stream. For example, if at least 75% of participants are no longer viewable in the video stream, the system can trigger the break. In another aspect, the system can prompt the remaining users to start a break if more than 50% of the participants are no longer viewable in the video stream, and automatically start a break if all except one of the participants are no longer in the video stream. One variation also includes the aspect of required participants whose absence necessitates a break. In another variation, the percentage of participants who have left is not based on overall participants, but only on invited participants. Other variations based on participants' status can be used. These and other variations can be used to trigger the beginning of a break.

The system 100 gathers information describing a current status of the video conference associated with the first time (504). In one aspect, the system 100 gathers the information from one or more other client devices in the video conference. In another aspect, the system 100 keeps track of this information continuously throughout the video conference for use with breaks.

The system 100 displays the information at the client device of the participant at a second time later than the first time (506). The information can be displayed as a semi-transparent overlay on top of the video conference, side by side with the video conference (possibly shrinking the video conference to make space to display the information side by side), as a temporary replacement for the video conference, blinking text and/or images, and/or as a scrolling feed overlaid over, above, below, or to the side of the video conference. These and other embodiments for displaying the enhanced break information can be used.

The system 100 can optionally detect an end of the break in the video conference, and stop displaying the information. For example, if the system 100 triggered the beginning of the break by detecting that all the human participants have left the video stream, the system 100 can automatically end the break when at least two of the invited, required, and/or other human participants have returned to the video stream.

In one aspect, each peer receives break data and/or break instructions in parallel with the video stream and modifies its own local display to present at least part of the break data and/or according to the break instructions. This approach allows for much more flexibility in user interactions with the break data. Further, each client can present different amounts and types of information during the break. In another aspect, an organizer client device and/or a server processes the video stream itself to incorporate the break data directly, in a similar fashion to a television broadcaster “branding” a broadcast with a logo. This approach limits the flexibility of some user interactions with the break data directly with the video stream, but would not limit the flexibility of user interactions via a side-channel such as interactions with a smartphone or a separate device.

The disclosure now turns to a discussion of a server-side break enhancing embodiment. As discussed above, the server can be a dedicated server or one of the client devices participating in the video conference. FIG. 6 illustrates an example server-side method embodiment for a client device participant to enhance a video conference break. In this example, the system 100 refers to the client device participant. The client device participant maintains a current status of a video conference connecting the client conferencing device to other client conferencing devices (602) and receives an indication of a beginning of a break in the video conference at a first time (604). The client device participant transmits at least part of the current status associated with the first time, at a second time later than the first time, to each of the other client conferencing devices for display to respective users of the other client conferencing devices (606). The client device participant can optionally detect an end of the break in the video conference, and transmit a command to each of the group of client devices to stop displaying the at least part of the current status.

In a variation where a dedicated server that is not a participant in the video conference enhances the video conference break, the server maintains a current status of a video conference connecting a group of client devices and monitors the video conference to detect a beginning of a break at a first time. When the server detects the beginning of the break, the server transmits at a second time later than the first time at least part of the current status associated with the first time to each of the group of client devices for display to respective users of the group of client devices. The server can optionally detect an end of the break in the video conference, and instruct each of the group of client devices to stop displaying the at least part of the current status.

In one variation, the server receives, from one of the client devices, a selection of an audiovisual feed to display during the break, such as a video loop, animation, text, images, music, audio messages, advertisements for an enterprise or sponsor, for example, and so forth. Conference participants can use this approach to enhance privacy and prevent other video conference participants from seeing their video feed during the break. The server can then transmit, during the break, the audiovisual feed received from the one client device to other client devices.

All or part of the break enhancements discussed and illustrated above can be used in other scenarios as well. For example, the agenda status can be shown on demand during non-break portions. As another example, the agenda status can be displayed on a “second screen” device or on a dedicated region of the screen. In one variation, all or part of the break status information is provided as a separate video feed as if the break status were a participant in the video conference. The system can also record the meeting in this way for playback during the break or after the conference.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied to other types of conferences, which may or may not include a video component, or to a one-way video stream, such as a live video broadcast. Those skilled in the art will readily recognize various modifications and changes that may be made to the principles described herein without following the example embodiments and applications illustrated and described herein, and without departing from the spirit and scope of the disclosure.

We claim:

1. A method of enhancing a video conference break, the method comprising:
detecting, at a client device of a participant in a video conference, at a first time associated with a beginning of a break in the video conference;
gathering information describing a current status of the video conference associated with the first time; and
displaying the information at the client device of the participant at a second time later than the first time.

2. The method of claim 1, further comprising:
detecting an end of the break in the video conference; and
stopping displaying the information.

3. The method of claim 1, wherein the information is displayed as a semi-transparent overlay on top of the video conference.

4. The method of claim 1, wherein the information is displayed side by side with the video conference.

5. The method of claim 4, further comprising shrinking the video conference to make space to display the information side by side.

6. The method of claim 1, wherein the information is displayed as a temporary replacement for the video conference.

7. The method of claim 1, wherein the information is displayed as a scrolling feed overlaid on the video conference.

8. The method of claim 1, wherein detecting the beginning of the break in the video conference is based on a user input.

9. The method of claim 8, wherein the user input is at least one of a button press, a touch gesture, a motion gesture, a voice command, a mouse click, and an agreement between at least two separately located participants in the video conference.

10. A system for enhancing a video conference break, the system comprising:
a processor;
a first module configured to control the processor to maintain a current status of a video conference connecting a plurality of client devices;
a second module configured to control the processor to monitor the video conference to detect a beginning of a break at a first time; and
when the beginning of the break is detected, a third module configured to control the processor to transmit at a second time later than the first time at least part of the current status associated with the first time to each of the plurality of client devices for display to respective users of the plurality of client devices.

11. The system of claim 10, further comprising:
a fourth module configured to control the processor to detect an end of the break in the video conference; and
a fifth module configured to control the processor to instruct each of the plurality of client devices to stop displaying the at least part of the current status.

12. The system of claim 10, further comprising:
a fourth module configured to control the processor to receive, from one of the plurality of client devices, a selection of an audiovisual feed to display during the break; and
a fifth module configured to control the processor to transmit, during the break, the audiovisual feed received from the one of the plurality of client devices to others of the plurality of client devices.

13. The system of claim 10, further comprising:
a fourth module configured to control the processor to detect progress of the video conference based on an agenda corresponding to the video conference; and
a fifth module configured to control the processor to update the agenda based on the progress detected.

14. The system of claim 13, wherein the at least part of the current status comprises the agenda.

15. The system of claim 13, wherein the fourth module is further configured to control the processor to detect the progress based on at least one of speech recognition, natural language processing, pattern matching, image detection, heuristics, and an indication received from one of a conference organizer and a conference participant.

16. The system of claim 10, wherein the at least part of the current status is transmitted as part of a video stream of the video conference.

17. The system of claim 10, wherein the at least part of the current status is transmitted as instructions to each of the plurality of client devices, the instructions causing each of the plurality of client device to display the at least part of the current status.

18. A non-transitory computer-readable storage medium storing instructions which, when executed by a client conferencing device, cause the client conferencing device to enhance a video conference break, the instructions comprising:
maintaining a current status of a video conference connecting the client conferencing device to other client conferencing devices;
receiving an indication of a beginning of a break in the video conference at a first time; and
transmitting at least part of the current status associated with the first time, at a second time later than the first time, to each of the other client conferencing devices for display to respective users of the other client conferencing devices.

19. The non-transitory computer-readable storage medium of claim 18, the instructions further comprising:
detecting an end of the break in the video conference; and
transmitting a command to each of the plurality of client devices to stop displaying the at least part of the current status.

20. The non-transitory computer-readable storage medium of claim 18, wherein the indication of the beginning of the break comprises at least one of a button press, a touch gesture, a motion gesture, a voice command, and a mouse click.
